(19) United States
(12) Patent Application Publication
(10) Pub. No.: US 2014/0139781 A1
(43) Pub. Date: May 22, 2014

(54) BACKLIGHT MODULE AND LCD DEVICE

(71) Applicant: SHENZHEN CHINA STAR OPTOELECTRONICS TECHNOLOGY CO. LTD., Shenzhen (CN)

(72) Inventors: Lifeng Wang, Shenzhen (CN); Yuchun Hsiao, Shenzhen (CN); Yicheng Kuo, Shenzhen (CN)

(73) Assignee: SHENZHEN CHINA STAR OPTOELECTRONICS TECHNOLOGY CO., LTD, Shenzhen, Guangdong (CN)

(21) Appl. No.: 13/704,997

(22) PCT Filed: Nov. 23, 2012
(86) PCT No.: PCT/CN12/85118

§ 371 Date: Dec. 18, 2012

(30) Foreign Application Priority Data
Nov. 22, 2012 (CN) 201210477255.8

(51) Int. Cl. G02F 1/1335; F21V 29/00

(52) U.S. Cl. CPC G02F 1/133608; F21V 29/22
USPC 349/58; 362/97.1

(57) ABSTRACT

The present disclosure provides a backlight module and a liquid crystal display (LCD) device. The backlight module includes a lightbar heat sink and a backplane. The lightbar heat sink defines a first fixing hole, and the backplane defines a second fixing hole. The backlight module further includes a connecting piece and a fastening piece. The connecting piece is fixed to the second fixing hole of the backplane and extended to an inside of the backplane, the first fixing hole of the lightbar heat sink is sleeved on the connecting piece, and the lightbar beat sink is fixed to the backplane by matching between the fastening piece and the connecting piece. The backplane can be more aesthetically pleasing, and can be directly used as a back cover of the LCD device.

### TECHNICAL FIELD

The present disclosure relates to the field of a liquid crystal displays (LCD) and more particularly to a backlight module and an LCD device.

### BACKGROUND

A liquid crystal display (LCD) device in the prior art generally includes an LCD panel and a backlight module. Because the LCD panel is unable to emit light, the backlight module should provide a surface light source to emit uniform light. As shown in FIG. 1, a light emitting diode (LED) lightbar 2 is used as a light source of an edge-light backlight module in general. Because the LED lightbar 2 emits high heat, a lightbar heat sink 3 is arranged to increase heat dissipation efficiency. The heat of the LED lightbar 2 is transferred to a backplane 1 by the lightbar heat sink 3, and then is dissipated into ambient air by the backplane 1.

In order to quickly and efficiently transfer the heat of the lightbar heat sink to the backplane, on one hand, the lightbar heat sink 3 should be made of material with a good heat transfer effect, such as an aluminum extrusion, but on the other hand, the lightbar heat sink 3 should be fully bonded to a inside surface of the backplane 1 to reduce thermal contact impedance between the lightbar heat sink 3 and the backplane 1. In the prior art, the lightbar heat sink defines a first fixing hole 31, the backplane 1 defines a second fixing hole 11, and the lightbar heat sink 3 is tightly locked on the backplane 1 by as screw 6. When the screw 6 is installed from an inside of the backplane 1, to increase locking strength of the screw 6, the backplane 1 is generally outwards configured with a folding edge 12 to the second fixing hole 11, causing the backplane 1 to not look so aesthetically pleasing and unable to be directly used as a back cover of the LCD device. When the screw 6 is installed from an outside of the backplane 1, only a head of the screw 6 is exposed to the outside of the backplane 1, thereby being more aesthetically pleasing. When assembling, the backplane 1 and the heat sink 3 need to be turned over and then inversely assembled. At this moment, the heat sink 3 is below the backplane 1. Because a size of the backplane 1 is larger, a relative position of the backplane 1 and the heat sink 3 may not be determined visually, resulting in difficult assembly and low efficiency.

### SUMMARY

In view of the above-described problems, the aim of the present disclosure is to provide a backlight module and a liquid crystal display (LCD) device. The backplane of the backlight module can meet appearance requirement, and can be directly used as a back cover of the LCD device.

A first technical scheme of the present disclosure is that: a backlight module composes a lightbar heat sink and a backplane. The lightbar heat sink defines a first fixing hole, and the backplane defines a second fixing hole. The backlight module further comprises a connecting piece and a fastening piece. The connecting piece is fixed to the second fixing hole of the backplane and extended to an inside of the backplane. The first fixing hole of the lightbar heat sink is sleeved on the connecting piece, the fastening piece is matched with the connecting piece to fix the lightbar heat sink to the backplane, the connecting piece is installed from an outside of the backplane, the second fixing hole is configured with a folding edge toward the inside of the backplane, the connecting piece is in a threaded connection and fixed to the folding edge, and the folding edge is configured with internal threads. The connecting piece is a bolt, and the fastening piece is a nut.

A second technical scheme of the present disclosure is that: a backlight module comprises a lightbar heat sink and a backplane. The lightbar heat sink defines a first fixing hole, and the backplane defines a second fixing hole. The backlight module further comprises a connecting piece and a fastening piece. The connecting piece is fixed to the second fixing hole of the backplane and extended to an inside of the backplane. The first fixing hole of the lightbar heat sink is sleeved on the connecting piece, and the fastening piece is matched with the connecting piece to fix the lightbar heat sink to the backplane.

In one example, the connecting piece is installed from the outside of the backplane.

In one example, the second fixing hole is configured with a folding edge toward the inside of the backplane, and the connecting piece is in a threaded connection and fixed to the folding edge. The folding edge makes the connecting piece firmly fix to the backplane and makes an axis of the connecting piece be perpendicular to the backplane, and has no influence on appearance of the backplane.

In one example, the connecting piece is fixed to the second fixing hole b a nut positioned on the inside of the backplane.

In one example, the connecting piece is a bolt, and the fastening piece is a nut

In one example, the connecting piece is a bolt, and one end of the bolt is configured with internal threads; the fastening piece is a screw, and the screw is matched with the internal threads of the connecting piece.

In one example, the connecting piece is a bolt, the fastening piece is a screw configured with internal threads, and the bolt is matched with the internal threads of the screw.

In one example, the folding edge is configured with internal threads.

A third technical scheme of the present disclosure is that: an LCD device comprises the backlight module mentioned above.

In one example, the backplane is a back cover of the LCD device. of the present disclosure are summarized below: in the backlight module of the present disclosure, the connecting piece is fixedly arranged on the backplane in advance, the connecting piece can be installed from the inside of the backplane and can be installed from the outside of the backplane as well, and the connecting piece is extended to the inside of the backplane; the lightbar heat sink is arranged on the backplane, and the first fixing hole is sleeved on the connecting piece; the fastening piece is installed from the inside of the backplane, the lightbar heat sink is fixed to the backplane by the matching between the connecting piece and the fastening piece. Because the outside of the backplane is not configured with folding edge, the backplane can meet the appearance requirement, and can be directly used as the back cover of the LCD device. Moreover, the backplane and the lightbar heat sink are forward assembled, and the relative positions of the backplane and the lightbar heat sink are easy to align, which make locking efficiency high.

### BRIEF DESCRIPTION OF FIGURES

FIG. 1 is a structural diagram of a backlight module in the prior an;

FIG. 2 is a structural diagram of a first example of a backlight module of the present disclosure;

FIG. 3 is an exploded view of a first example of a backlight module of the present disclosure;

FIG. 4 is a structural diagram of a second example of a backlight module of the present disclosure;

FIG. 5 is a structural diagram of a third example of a backlight module of the present disclosure; and

FIG. 6 is a structural diagram of a fourth example of a backlight module of the present disclosure.

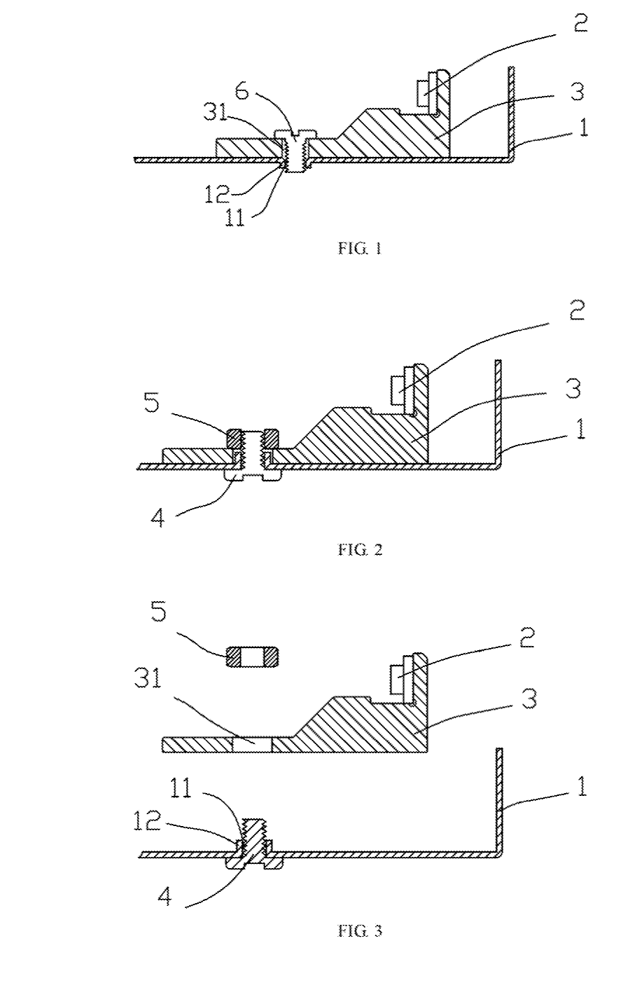

### DETAILED DESCRIPTION

The present disclosure provides a liquid crystal display (LCD) device, comprising a backlight module. FIG. 2 and. FIG. 3 show a first example of the backlight module of the present disclosure. The backlight module comprises a lightbar heat sink 3 and a backplane 1. A light emitting diode (LED) lightbar 2 is arranged on the lightbar heat sink 3, the lightbar heat sink defines a first fixing hole 31, and the backplane 1 defines a second fixing hole 11. The backlight module further comprises a connecting piece 4 and a fastening piece 5. The connecting piece 4 is fixed to the second fixing hole 11 of the backplane and extended to an inside of the backplane 1. The first fixing hole 31 of the lightbar heat sink 3 is sleeved on the connecting piece 4, and the lightbar heat sink 3 is fixed to the backplane 1 by matching between the fastening piece 5 and the connecting piece 4. In the example, the connecting piece is installed from an outside of the backplane 1.

In the backlight module of the present disclosure, the connecting piece 4 is arranged on the backplane 1 in advance, and the connecting piece 4 can be installed from the inside of the backplane 1 and can be installed from the outside of the backplane 1 as well. The connecting piece 4 is extended to the inside of the backplane 1, then, the lightbar heat sink 3 is arranged on the backplane 1. The first fixing hole 31 is sleeved on the connecting piece 4, then the fastening piece 5 is installed from the inside of the backplane 1, and the lightbar heat sink 3 is fixed to the backplane 1 by the matching between the connecting piece 4 and the fastening piece 5. Because the outside of the backplane is not configured with a folding edge, the backplane can be more aesthetically pleasing, and can be directly used as a back cover of the LCD device. Moreover, the backplane 1 and the lightbar heat sink 3 are installation from top to bottom, and relative positions of the backplane 1 and the lightbar heat sink 3 are easy to align, which makes locking efficiency high.

In the example, the connecting piece 4 is a bolt, and the fastening piece 5 is a nut. The second fixing hole 11 is configured with a folding edge 12 toward the inside of the backplane 1, the folding edge is configured with internal threads, and the connecting piece is in a threaded connection and fixed to the folding edge 12. The folding edge 12 enables the connecting piece 4 to be more firmly fixed to the backplane 1, and better ensures that an axis of the connecting piece 4 is perpendicular to the backplane 1.

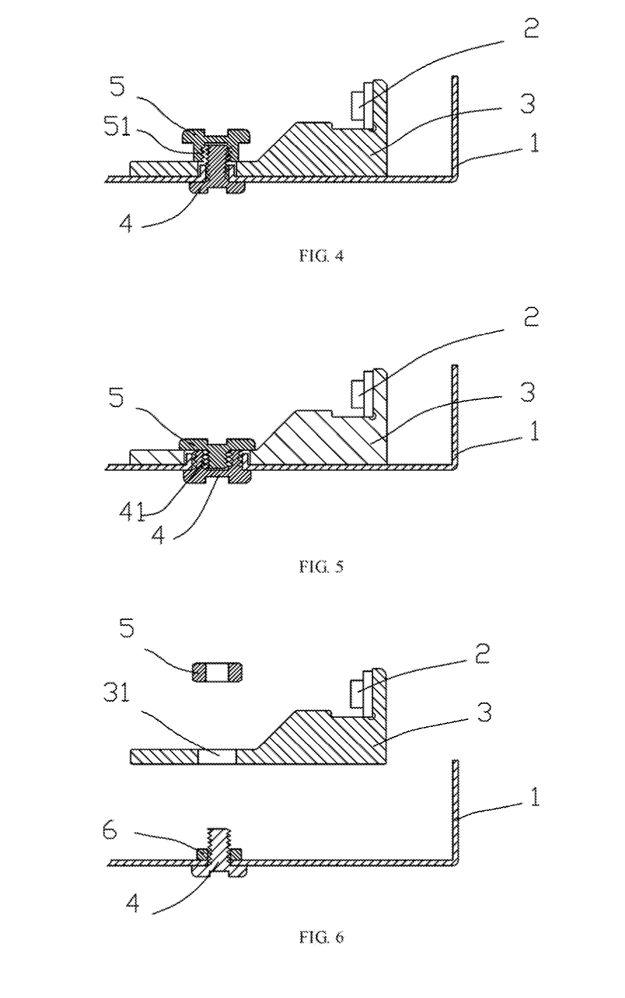

FIG. 4 shows a second example of the backlight module of the present disclosure, and the second example is different from the first example in that: the connecting piece 4 is a bolt, the fastening piece 5 is a screw configured with internal threads 51, the bolt is matched with the internal threads 51 of the screw, and the lightbar heat sink 3 is locked on the backplane 1 by the fastening piece 5. Other structures, assembly methods and advantages are consistent with assembly methods and advantages of the first example, thus, the example will not give unnecessary details.

FIG. 4 shows a third example of the backlight module of the present disclosure, and the third example is different from the first example in that: the connecting piece 4 is a bolt, and one end of the fastening piece 5 is configured with internal threads 41. The fastening piece 5 is a screw, the screw is matched with the internal threads 41 of the connecting piece 4, and the lightbar heat sink 3 is locked on the backplane 1 by the fastening piece 5. Other structures, assembly methods and advantages are consistent with assembly methods and advantages of the first example, thus, the example will not give unnecessary details.

FIG. 6 shows a fourth example of the backlight module of the present disclosure, and the fourth example is different from the first example in that: the second fixing hole 11 of the backplane 1 is not configured with folding edge, and the connecting piece 4 is fixed to the second fixing bole 11 by the nut 6 positioned inside the backplane 1. Locking efficiency is high because the fastening piece 5 locks from the top down. Other structures, assembly methods and advantages are consistent with t assembly methods and advantages of the first example, thus, the example will not give unnecessary details.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong, to the protection scope of the present disclosure.

1. A backlight module, comprising:
a lightbar heat sink and a backplane, wherein the lightbar heat sink defines a first fixing hole, and the backplane defines a second fixing hole; and
a connecting piece and a fastening piece; wherein the connecting piece is fixed to the second fixing hole and extended to an inside of the backplane, the first fixing hole of the lightbar heat sink is sleeved on the connecting piece, the lightbar heat sink is fixed to the backplane by matching between the fastening piece and the connecting piece;
wherein the connecting piece is installed from an outside of the backplane, the second fixing hole is configured with a folding edge towards the inside of the backplane, the connecting piece is in a threaded connection and fixed to the folding edge, and the folding edge is configured with internal threads; the connecting piece is a bolt, and the fastening piece is a nut.

2. A backlight module, comprising:
a lightbar heat sink and a backplane, wherein the lightbar heat sink defines a first fixing hole, and the backplane defines a second fixing hole; and
a connecting piece and a fastening piece; wherein the connecting piece is fixed to the second fixing hole of the backplane and extended to an inside of the backplane, the first fixing hole of the lightbar heat sink is sleeved on the connecting piece, and the lightbar heat sink is fixed to the backplane by matching between the fastening piece and the connecting piece.

3. The backlight module of claim 2, wherein the connecting piece is installed from an outside of the backplane.

4. backlight module of claim 3, wherein the second fixing hole is configured with a folding edge towards the inside of the backplane, and the connecting piece is in a threaded connection and fixed to the folding edge.

5. The backlight module of claim 3, wherein the connecting piece is fixed to the second fixing hole by a nut positioned on the inside of the backplane.

6. The backlight module of claim 2, wherein the connecting piece is a bolt, and the fastening piece is a nut.

7. The backlight module of claim 2, wherein the connecting piece is a bolt, one end of the bolt is configured with internal threads; the fastening piece is a screw, and the screw is matched with the internal threads of the connecting piece.

8. The backlight module of claim 2, wherein the connecting piece is a bolt, the fastening piece is a screw configured with internal threads, and the bolt is matched with the internal threads of the screw.

9. The backlight module of claim 4, wherein the folding edge is configured with internal threads.

10. A liquid crystal display (LCD) device, comprising:
a backlight module comprising a lightbar heat sink backplane, a connecting piece, and a fastening piece; wherein the lightbar heat sink defines a first fixing hole, and the backplane defines a second fixing hole; the connecting piece is fixed to the second fixing hole of the backplane and extended to an inside of the backplane, the first fixing hole of the lightbar heat sink is sleeved on the connecting piece, and the lightbar heat sink is fixed to the backplane by matching between the fastening piece and the connecting piece.

11. The liquid crystal display (LCD) device of claim 10, wherein the connecting piece is installed from an outside of the backplane.

12. The liquid crystal display (LCD) device of claim 11, wherein the second fixing, hole is configured with a folding edge towards the inside of the backplane, and the connecting piece is in a threaded connection and fixed to the folding edge.

13. The liquid crystal display (LCD) device of claim 11, wherein the connecting piece is fixed to the second fixing hole by a nut positioned on the inside of the backplane.

14. The liquid crystal display (LCD) device of claim 10, wherein the connecting piece is a bolt, and the fastening piece is a nut.

15. The liquid crystal display (LCD) device of claim 10, wherein the connecting piece is a bolt, one end of the bolt is configured with internal threads; the fastening piece is a screw, and the screw is matched with the internal threads of the connecting piece.

16. The liquid crystal display (LCD) device of claim 10, wherein the connecting piece is a bolt, the fastening piece is a screw configured with internal threads, and the bolt is matched with the internal threads of the screw.

17. The liquid crystal display (LCD) device of claim 12, wherein the folding edge is configured with internal threads.

18. The liquid crystal display (LCD) device of claim 10, wherein the backplane is a back cover of the LCD device.
